(19) United States
(12) Patent Application Publication
(10) Pub. No.: US 2013/0103628 A1
(43) Pub. Date: Apr. 25, 2013

(54) USER ACTIVITY DASHBOARD FOR DEPICTING BEHAVIORS AND TUNING PERSONALIZED CONTENT GUIDANCE

(71) Applicant: Sidebar, Inc., Redondo Beach, CA (US)

(72) Inventors: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US)

(73) Assignee: Sidebar, Inc., Redondo Beach, CA (US)

(21) Appl. No.: 13/657,613

(22) Filed: Oct. 22, 2012

Related U.S. Application Data
(60) Provisional application No. 61/549,703, filed on Oct. 20, 2011.

(51) Int. Cl. G06N 5/02

(52) U.S. Cl. 706/46

(57) ABSTRACT

User activity dashboards and methods for tuning recommendation models are provided herein. Exemplary methods may include exposing, to an end user device, a current preference model used by a recommendation engine to provide recommendations to the end user, receiving a modification to the current preference model, generating a modified preference model with the modification, and applying the modified preference model to generate recommendations for the end user that are more relevant than the recommendations provided using the current preference model.

This application claims the benefit of U.S. Provisional Patent Application Ser. No. 61/549,703, filed on Oct. 20, 2011, and entitled “User Activity Dashboard for Depicting Behaviors and Tuning Personalized Content Guidance” which is hereby incorporated herein by reference in its entirety including all references cited therein.

### FIELD OF THE INVENTION

Systems, methods, and media that provide user activity dashboards for depicting end user viewing behaviors and tuning of personalized content or recommendation models are provided herein.

### BACKGROUND

Currently, content recommendation engines are utilized to display to each user the content that is relevant to their individual tastes. These recommendation engines may make approximations of an individual's preferences based on the collection of behavior data that results from the user's interactions with content and their interactions with the subsequent recommendations created from this collection of data. Currently, content recommendation engines give a user limited insight into the process of how these approximations are made, and with what data is being used.

Additionally, systems that utilize recommendation engines may not give the user the ability to edit this data to ensure that the data is accurate. For instance, if a user is presented with a content recommendation that is determined by the user to not match their personal taste, the user has limited means to “correct” the results in order for the recommendation engine to become more “tuned” to the user's tastes. Typically, a user is presented with a content recommendation that is suited to someone else that has used the user's device (e.g. a child watching a movie from a parent's device), and the user may have limited means to correct the recommendation engine's understanding of this incident.

### SUMMARY OF THE PRESENT TECHNOLOGY

According to some embodiments, the present technology may be directed to methods that comprise: (a) exposing, to an end user device, a current preference model used by a recommendation engine to provide recommendations to the end user; (b) receiving a modification to the current preference model; (c) generating a modified preference model with the modification; and (d) applying the modified preference model to generate recommendations for the end user that are more relevant than the recommendations provided using the current preference model.

According to exemplary embodiments, the present technology may be directed to systems that comprise: (a) a processor; (b) logic encoded in one or more tangible media for execution by the processor and when executed operable to perform operations comprising: (i) exposing, to an end user device, a current preference model used by a recommendation engine to provide recommendations to the end user; (ii) receiving a modification to the current preference model; (iii) generating a modified preference model with the modification; and (iv) applying the modified preference model to generate recommendations for the end user that are more relevant than the recommendations provided using the current preference model.

According to some embodiments, the present technology may be directed to methods that comprise: (a) generating a dashboard that includes representations of current end user generated data used by a recommendation engine to provide recommendations to the end user; (b) receiving, via the dashboard, a modification to the end user generated data used by the recommendation engine; and (c) generating recommendations for the end user that are more relevant than the recommendations provided using the current end user generated data.

According to other embodiments, the present technology may be directed to a non-transitory machine-readable medium having embodied thereon a program. In some embodiments the program may be executed by a machine to perform a method. The method may comprise: (a) exposing, to an end user device, a current preference model used by a recommendation engine to provide recommendations to the end user; (b) receiving a modification to the current preference model; (c) generating a modified preference model with the modification; and (d) applying the modified preference model to generate recommendations for the end user that are more relevant than the recommendations provided using the current preference model.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary architecture in which embodiments of the present technology may be practiced;

FIG. 2 illustrates an exemplary dashboard user interface;

FIG. 3 is a flowchart of an exemplary method for improving recommendations generated by a recommendation engine, based upon preference model tuning; and

FIG. 4 illustrates an exemplary computing system that may be used to implement embodiments according to the present technology.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology provides for user activity dashboards for use with set top boxes, televisions, computers, tablets, mobile phones, and other devices. These dashboards may graphically display viewing behaviors of a user which have been determined from end user generated content, such as when a user interacts with programming as well as programming recommendations generated by a recommendation engine. An exemplary User Activity Dashboard (UAD) for depicting and tuning personalized content guidance may enable the user to edit the various types of displays of their behaviors, along with recommendations from the recommendation engine in order to tune its guidance.

In some instances, exemplary dashboards may include a graphical user interface that includes interactive features that enable end users to view user behavior data that the recommendation engine is using to influence a model of prediction about content. Additionally, exemplary dashboards may allow end users to view a display of aggregated behavior data to give end users insight into their content engagement activity. Advantageously, these dashboards may enable users to view, control, and modify the user behavior data in order to ensure accuracy and tune the preference models used by the recommendation engine.

In some instances, these dashboards may enable users to preview recommendations and predictions in order to increase future relevancy of the recommendations generated by the recommendation engine.

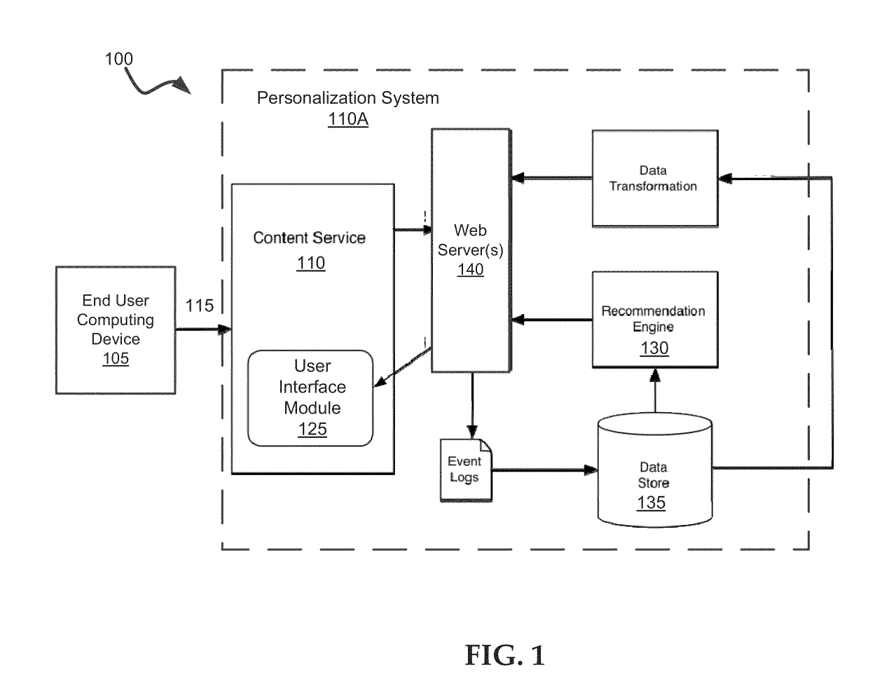

It will be understood that the terms “user behavior data” may generally be referred to as end user generated content, although end user generated content may include additional types of analytical or empirical data such as web analytics. These and other advantages of the present technology will be described in greater detail below relative to the collective drawings (e.g., FIGS. 1-4).

Referring now to the drawings, and more particularly, to FIG. 1, which includes a schematic diagram of an exemplary architecture 100 for practicing the present invention. Architecture 100 may include an end user computing system 105, which is communicatively coupled with a content service 110 via a communications path 115. Again, the content service 110 may comprise any suitable system for delivering broadcast content, keeping in mind that broadcast content may comprise any type of content that is “broadcast” over a network connection, although other traditional methods of broadcasting using satellites or antenna transmission are also likewise contemplated for use in accordance with the present technology. Thus, although the communications path 115 is shown as comprising a direct path between the end user computing system 105 and the content service 110, the communications path 115 may comprise a plurality of communications paths that allow for the communication of program guide signals and/or broadcast content signals from the content service 110 to the end user computing system 105.

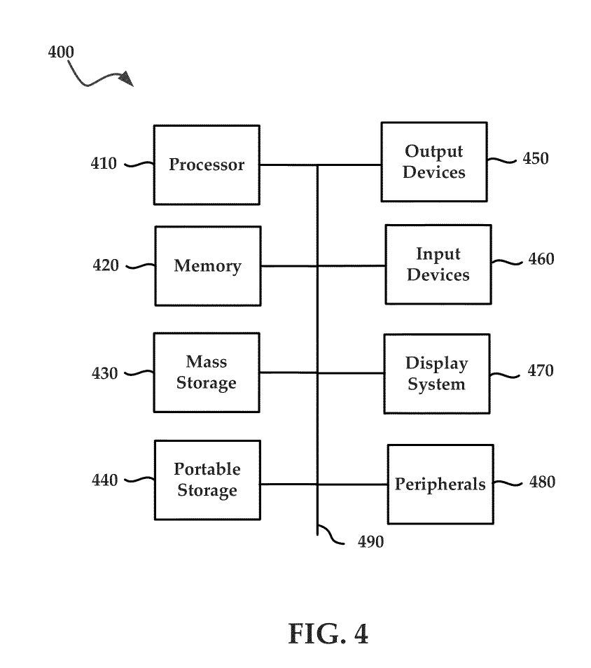

In some instances, the content service 110 may comprise a personalization system 110A. The personalization system 110A may comprise a processor for executing instructions stored in memory of a computing device. The computing device may be a constituent part of the personalization system 110A and may comprise a server or other suitable computing device that may be utilized to deliver broadcast content, a programming guide, or user activity dashboards to the end user computing system 105. Additional details regarding an exemplary computing system are found in FIG. 4, and corresponding disclosure provided below.

According to some embodiments, the personalization system 110A, which in turn comprises a user interface module 125 and a recommendation engine 130. It is noteworthy that the executable instructions may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules may include separately configured web servers. Also, the modules may be provisioned with a cloud.

In some instances, the personalization system 110A may be implemented within a cloud-based computing environment. In general, a cloud-based computing environment is a resource that typically combines the computational power of a large model of processors and/or that combines the storage capacity of a large model of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

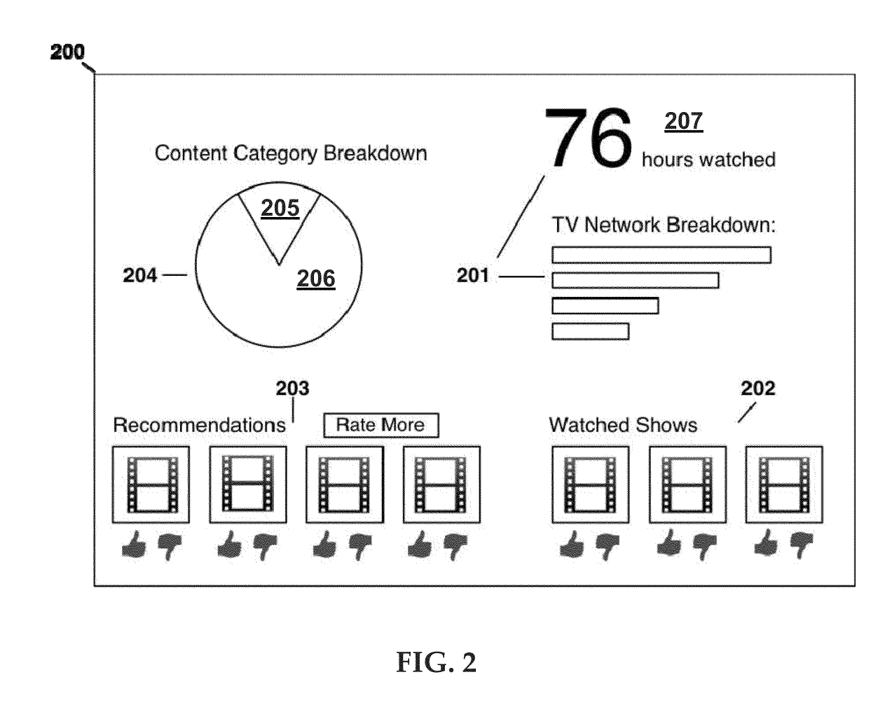

The user interface module 125 may be executed to generate various graphical user interfaces. Graphical user interfaces may include, but are not limited to electronic program guides, and user activity dashboards that display data used by the recommendation engine 130 to generated preference models for an end user. In some instances, the dashboards may include interactive interfaces that allow end users to view and modify the data used by the recommendation engine 130. An exemplary user interface generated by the user interface module 125 will be described in greater detail below relative to FIG. 2.

Prior to the generation of user activity dashboards, end user preference data may be obtained by the recommendation engine 130 from a wide variety of sources. Non-limiting examples may comprise explicit preference data obtained from end user actions such as deliberate program selection, downloading content, queuing broadcast content, and so forth. Additionally, implicit or incidental preference data may be inferred/obtained by analyzing other types of data such as search engine queries/responses, social media messages, device characteristics and usage patterns, and so forth.

In some instances, captured user behavior data at the end user computing system 105 may be transmitted to the personalization system 110A via an application programming interface (API) or the bulk delivery of event logs, via the communications path 115. Data from event logs that comprise observed user behaviors may be stored in a data store 135.

According to some embodiments, the recommendation engine 130 may, for example, reside on a server environment and/or locally on the end user computing system 105, such as a set top box. The recommendation engine 130 may receive previous content interaction behavior(s) exhibited by a user and renders them in a data store. The recommendation engine 130 may apply algorithms to the stored user behavioral data, as well as content meta-data, which may for example be persisted locally and/or remotely in a data store, in order to analyze each individual user's content tastes/preferences and make predictions or recommendations of the content they are likely to consume. Multiple variables may play a role in generating the derived predictions.

According to some embodiments, different types of user viewing behaviors may be evaluated by the recommendation engine 130 to generate derived predictions (e.g., implicit or inferred) including, but not limited to the programs that a user watches, does not watch, records, watches a preview of, rates, and shares on a social network—just to name a few. Viewing behaviors may also include length of the programs the user watches, length of time that the user spends watching, the time of day the user watches, the day of week that the user watches, the origin of the programming the user watches (e.g., live television broadcasts, DVD, video on demand (VOD), and ancillary television services such as Netflix® and Hulu , and so forth).

Additionally, preference information may be gathered from the type of device the end user utilizes to watch broadcast content, the delivery method of the broadcast content (e.g., streaming video over a network, VOD, pay per view, live television, and so forth), and any combination of the preceding examples or additional examples that would be known to one of ordinary skill in the art. Viewing behaviors may also include the viewing details about the broadcast content the user watches (also what the end user downloads, selects, purchases, queues, etc.) such as the actors, directors, producers, locations, date of origin, as well as the genre, synopsis, theme, mood related details, and any other descriptive information that may be determined about the broadcast content.

Additionally, the recommendation engine 130 may determine or infer negative viewing behaviors about an end user. Negative viewing behaviors may include information that an end user does not watch certain programming at certain times of the day and/or day of the week or that the end user does not watch broadcast content that is associated with a certain origin. In other instances, negative viewing behaviors may indicate that the end user does not watch certain broadcast content on a certain devices. For example, the end user may not watch movies on their mobile devices. Other negative viewing behaviors that would be known to one of ordinary skill in the art are likewise contemplated for use in accordance with the present technology.

According to some embodiments, the recommendation engine 130 may receive preference data regarding any of the previously described types of end user preference data, namely end user viewing behaviors. In other instances, the recommendation engine 130 may capture end user behaviors by monitoring activity occurring on the end user computing system 105. In some instances, the recommendation engine 130 may function as a proxy or intermediary device that receives signals communicated between the content service 110 and the end user computing system 105. The recommendation engine 130 may parse these signals to determined end user behavior and generate preference data. In some instances, the recommendation engine 130 may render the preference data in a data store, where the preference data may be maintained in a database or individual end user records.

The recommendation engine 130 may apply algorithms to the stored user behavioral data, as well as content meta-data, which may persist locally and/or remotely in a data store, for example. The algorithm utilized by the recommendation engine 130 may be used to analyze the end user content tastes/preferences and make predictions or recommendations of broadcast content for which the end user is likely to have a preference.

Multiple variables may play a role in the derivation of recommended content by the recommendation engine 130. For example, the recommendation engine 130 may recommend content that is suited to a particular time of the day and/or day of the week for the end user. The recommendation engine 130 may recommend content based on the length of time the user has available to watch content at a particular time of day and/or day of the week. In other instances the recommendation engine 130 may recommend content based upon the user's mood at a particular time of day and/or day of the week. In other instances, the recommendation engine 130 may automatically queue upcoming programs for recording (such as with a digital video recorder “DVR” or other recording device) if the upcoming programs are determined to be of interest to the end user.

Regardless of how user behavior data are obtained, such data may be used by the recommendation engine 130 to derive prediction models of the participating user base. Generally, stored data regarding end user behavior such as viewing behaviors may be used by a data transformation process to derive data sets for display on a user activity dashboard. The transformed data may be transmitted to web server(s) 140 or cache for delivery to the content service 110. The user interface module 125 may then generate user activity dashboards that include the user behavior data.

This information may be presented on the dashboard in many ways such as via graphical representations. Exemplary graphical representations may include, but are not limited to, pie chart having percentages of classifications of content consumed, a bar chart, an ordered list, and so forth.

One exemplary user interface may include a user interface dashboard that enables users to see the user behavior data that the recommendation engine 130 is using to influence a preference model to generate recommended offerings of content. Exemplary recommended offerings may include television programs, movies, music, or other various types of broadcast content.

An additional exemplary user interface may display content interaction behaviors (e.g., end user generated data) that are being used by the recommendation engine 130 to derive predictions, such as broadcast content that may be of interest to the end user. This user interface may expose all or a portion of the interactive behaviors that the recommendation engine 130 (or any other data collection mechanism) collects regarding the end user that the recommendation engine 130 may utilize. Additionally, the user interface may reveal only interaction behaviors that are being used to derive predictions. For instance, the recommendation engine 130 may collect many user interactions, but may analyze the data and determine that only certain interactions have predictive qualities. These preferred interactions may also be learned from end user feedback, such as selection of interactions by the end user.

Another exemplary user interface may include visual depictions of aggregations of data about user behaviors in a manner that gives the end user insights into their behaviors.

In another exemplary embodiment, an interactive user interface may enable users to control and change the user behavior data in order to ensure accuracy and tune the recommendation engine 130. For example, users may be allowed to edit the information presented via the dashboard in order to gain control of the recommendation engine 130 and to tune the preference model or data used to create the preference model in such a way that the end user increases the accuracy of the personalized content/recommended offerings provided by the recommendation engine 130.

FIG. 2 illustrates an exemplary graphical user interface in the form of a user activity dashboard 200. In one embodiment, the dashboard 200 may display representations of actual user behaviors. The end user may “tune” the recommendation engine 130 by changing these graphical displays to reflect the desires of the end user, rather than what is displayed. For instance, the dashboard may include a pie chart 204 that illustrates types of genres a user has watched. Thus, user generated content that has been aggregated into categories 205 and 206 such as “Sports” and “News,” respectively.

On this pie chart 204, “Sports” appears as a genre that is 75% of the programming a viewer has watched. The “News” category 206 comprises the remaining 25% of the pie chart 204.

Assuming that the end user does not want to receive recommendations for Sports programs (for example if the end user already knows what games they want to see), the end user may have the ability to lower the percentage of sports to a lesser percentage, whereby the recommendation engine may assign proportionally less weight to sports in the predictive model that it uses for that individual user. The end user may interact with the pie chart 204 to change the percentages of the categories. Changing of the percentages, in turn, affects the recommendations generated by the recommendation engine 130.

The interface 200 may also include data driven elements, such as a bar chart 201 that illustrates the user's interactions with a target service, such as television broadcasts. The bar chart 201 may display categories of user generated data, such as aggregate hours spent watching a particular channel (e.g., TV Network Breakdown). The interface 200 may also include an aggregated number of hours 207 of content consumed, as indicated from the end user generated data.

The interface 200 is shown as including data driven elements which illustrate captured interactions between a user and a target service enabling the user to make changes by explicitly rejecting content, which may have a direct impact on subsequent predicted output for a given user as derived from a recommendation engine 130. For example, a list 202 of watched shows is provided. Each element in the list 202 may be accepted or rejected by clicking a thumbs up or thumbs down icon located below each element in the list 202. Other methods for approving or rejecting user generated content may also likewise be utilized.

The interface 200 may also include elements directly representing the output from a recommendation engine, enabling the user to explicitly tune the recommendation engine's perception of the user by rating/ranking/scoring content predicted for consumption. For example, a list 203 of recommendations (e.g., recommended offerings) is illustrated. Each element in the list 202 may be accepted or rejected by clicking a thumbs up or thumbs down icon located below each element in the list 202. Other methods for approving or rejecting user generated content may also likewise be utilized.

In another embodiment, an exemplary interface may include viewable repetitions that enable the end user to see a list of the most recent content consumed over a selected period of time (e.g., five days, five weeks, five months, and so forth). The interface may include mechanisms that the end user to rate the content they have watched to indicate that they liked or disliked the content, and they may have the ability to delete a program from their list entirely so that the recommendation engine 130 may know that it was not a program that they viewed. For example, in a household of users that has many accounts on the same device or service, users may have the ability to “assign” a piece of content viewed from a list to another individual so that the recommendation engine 130 knows who in that household consumes particular types of content.

Exemplary interfaces may include mechanisms that the end user to preview recommendations and predictions in order to increase relevancy of the recommendation engine 130. Additionally exemplary interfaces may include mechanisms that the end user to preview recommendations and predictions being derived from the recommendation engine 130 in order to ensure the accuracy of these predictions. This may be accomplished in a number of ways. By way of non-limiting example, the user may be able to see or preview the actual recommended offerings from the recommendation engine 130 that may be made the next time they access a screen that shows recommended offerings, such as the recommended offerings list 203 of FIG. 2. Thus, end users may tune the recommendation engine 130 by informing the recommendation engine 130 as to whether the end user is interested in this content by rating the recommendations. End user may also preview future recommendations, which may also be altered or updated in real-time as end users rate recommendations generated by the recommendation engine 130.

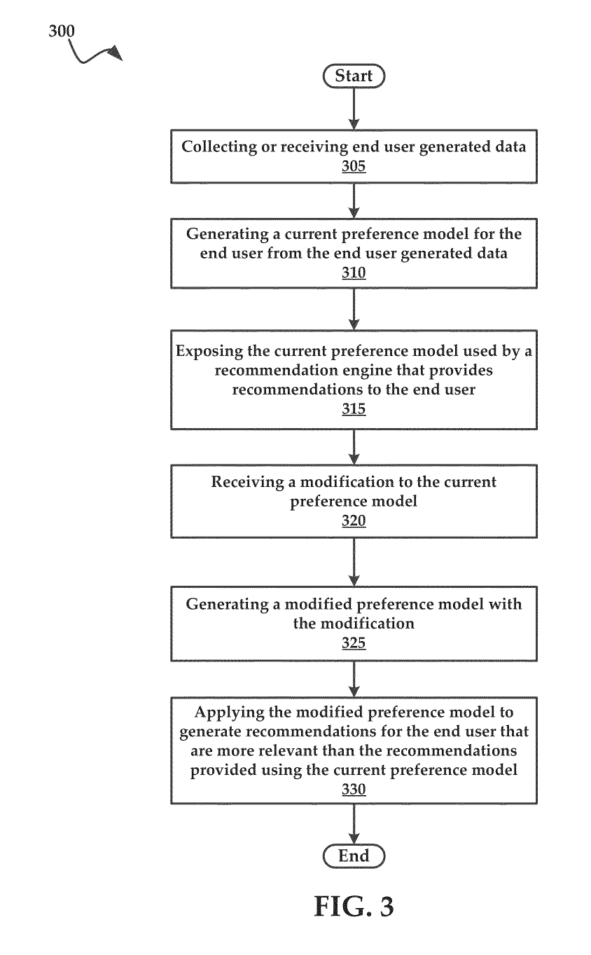

FIG. 3 is a flowchart of an exemplary method 300 for improving recommendations generated by a recommendation engine, based upon preference model tuning. The method 300 may comprise a step of collecting end user generated data. Many methods for collecting or receiving end user generated data are provided in greater detail above, but exemplary end user generated data may include content purchases, viewing behaviors, and so forth.

Upon collecting end user generated data, the method 300 may comprise a step 310 of generating a current preference model for the end user. The preference model may include analysis of aggregated categories of viewer behaviors, which may be used to infer end user preferences and suggest recommended offerings for the end user. The preference model may be generated using various recommendation algorithms, which are used to calculate preferences from viewer behavior metrics such as channels watched, program viewing duration, channels avoided, movies purchased, and so forth. The preference model may also account for various end user data included in user profiles that may be established by the end user, or may be created from various sources, such as web analytics.

After a preference model for the end user has been created, the method 300 may include a step 315 of exposing the current preference model used by a recommendation engine that provides recommendations to the end user. In some instances, exposing the current preference model may include generating a user activity dashboard that includes, for example, various end user generated data that has been used by the engine to create the current preference model. The end user generated data may be displayed as graphs, charts, lists, or other aggregations or categories of end user generated content. For example, end user generated data such as channel viewing metrics may be used to generate a pie chart that provides a visual representation of the aggregate number of minutes that the end user spent watching various channels.

In other instances, exposing the current preference model may include providing the end user with one or more recommendation algorithms used by the recommendation engine.

Next, the method 300 may include a step 320 of receiving a modification to the current preference model. This step may include the end user selecting what type of end user generated content that they would like to be used. This list may include a tailored list of end user generated content. In other instances, step 320 may include the end user modifying a graphical representation such as the wedges of a pie chart or bars of a histogram to selectively adjust the weight assigned to a particular category of content or behaviors. In other instances, this step may include selecting from a plurality of user profiles. According to some embodiments, the end user may be allowed to select the specific recommendation algorithm used by the recommendation engine.

Next, the method 300 may include a step 325 of generating a modified preference model with the modification as well as a step 330 of applying the modified preference model to generate recommendations for the end user that are more relevant than the recommendations provided using the current preference model.

Although not shown, the method may also comprise optional steps of providing preview recommendations to the end user device, receiving feedback regarding the preview recommendations, and modifying the current preference model using the feedback.

FIG. 4 illustrates an exemplary computing system 400 that may be used to implement an embodiment of the present systems and methods. The system 400 of FIG. 4 may be implemented in the contexts of the likes of computing systems, networks, servers, or combinations thereof. The computing system 400 of FIG. 4 includes one or more processors 410 and main memory 420. Main memory 420 stores, in part, instructions and data for execution by processor 410. Main memory 420 may store the executable code when in operation. The system 400 of FIG. 4 further includes a mass storage device 430, portable storage device 440, output devices 450, user input devices 460, a display system 470, and peripheral devices 480.

The components shown in FIG. 4 are depicted as being connected via a single bus 490. The components may be connected through one or more data transport means. Processor unit 410 and main memory 420 may be connected via a local microprocessor bus, and the mass storage device 430, peripheral device(s) 480, portable storage device 440, and display system 470 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 may store the system software for implementing embodiments of the present invention for purposes of loading that software into main memory 420.

Portable storage device 440 operates in conjunction with a portable non-volatile storage medium, such as a floppy disk, compact disk, digital video disc, or USB storage device, to input and output data and code to and from the computer system 400 of FIG. 4. The system software for implementing embodiments of the present invention may be stored on such a portable medium and input to the computer system 400 via the portable storage device 440.

User input devices 460 provide a portion of a user interface. User input devices 460 may include an alphanumeric keypad, such as a keyboard, for inputting alpha-numeric and other information, or a pointing device, such as a mouse, a trackball, stylus, or cursor direction keys. Additional user input devices 460 may comprise, but are not limited to, devices such as speech recognition systems, facial recognition systems, motion-based input systems, gesture-based systems, and so forth. For example, user input devices 460 may include a touchscreen. Additionally, the system 400 as shown in FIG. 4 includes output devices 450. Suitable output devices include speakers, printers, network interfaces, and monitors.

Display system 470 may include a liquid crystal display (LCD) or other suitable display device. Display system 470 receives textual and graphical information, and processes the information for output to the display device.

Peripherals device(s) 480 may include any type of computer support device to add additional functionality to the computer system. Peripheral device(s) 480 may include a modem or a router.

The components provided in the computer system 400 of FIG. 4 are those typically found in computer systems that may be suitable for use with embodiments of the present invention and are intended to represent a broad category of such computer components that are well known in the art. Thus, the computer system 400 of FIG. 4 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
executing instructions via a processor, the instructions comprising:
exposing, to an end user device, a current preference model used by a recommendation engine to provide recommendations to the end user;
receiving a modification to the current preference model;
generating a modified preference model with the modification; and
applying the modified preference model to generate recommendations for the end user that are more relevant than the recommendations provided using the current preference model.

2. The method according to claim 1, wherein the current preference model comprises any of end user generated data, an end user behavior profile, one or more recommendation algorithms, content metadata, and combinations thereof.

3. The method according to claim 2, further comprising aggregating the end user generated data into behavior categories.

4. The method according to claim 2, wherein the end user generated data comprises content consumption data and consumed content attributes.

5. The method according to claim 1, wherein the exposing includes generating a user activity dashboard that includes the current preference model.

6. The method according to claim 5, wherein the user activity dashboard comprises an interactive graphical representation of end user generated data organized into categories, the interactive graphical representation allowing an end user to selectively adjust the categories to tune the end user generated data.

7. The method according to claim 1, further comprising:
providing preview recommendations to the end user device;
receiving feedback regarding the preview recommendations; and
modifying the current preference model using the feedback.

8. The method according to claim 1, wherein receiving a modification to the current preference model comprises receiving an assignment of end user generated content from a first end user to a second end user.

9. A system, comprising:
a processor;
logic encoded in one or more tangible media for execution by the processor and when executed operable to perform operations comprising:
exposing, to an end user device, a current preference model used by a recommendation engine to provide recommendations to the end user;
receiving a modification to the current preference model;
generating a modified preference model with the modification; and
applying the modified preference model to generate recommendations for the end user that are more relevant than the recommendations provided using the current preference model.

10. The system according to claim 9, wherein the current preference model comprises any of end user generated data, an end user behavior profile, one or more recommendation algorithms, content metadata, and combinations thereof.

11. The system according to claim 10, wherein the processor further executes the logic to perform operations of aggregating the end user generated data into behavior categories.

12. The system according to claim 10, wherein the end user generated data comprises content consumption data and consumed content attributes.

13. The system according to claim 9, wherein the exposing includes generating a user activity dashboard that includes the current preference model.

14. The system according to claim 13, wherein the user activity dashboard comprises an interactive graphical representation of end user generated data organized into categories, the interactive graphical representation allowing an end user to selectively adjust the categories to tune the end user generated data.

15. The system according to claim 9, wherein the processor further executes the logic to perform operations of:
providing preview recommendations to the end user device;
receiving feedback regarding the preview recommendations; and
modifying the current preference model using the feedback.

16. The system according to claim 9, wherein receiving a modification to the current preference model comprises receiving an assignment of end user generated content from a first end user to a second end user.

17. A method, comprising:
executing instructions via a processor, the instructions comprising:
generating a dashboard that includes representations of current end user generated data used by a recommendation engine to provide recommendations to the end user;
receiving, via the dashboard, a modification to the end user generated data used by the recommendation engine; and
generating recommendations for the end user that are more relevant than the recommendations provided using the current end user generated data.
